(19) United States
(12) Patent Application Publication
(10) Pub. No.: US 2022/0255944 A1
(43) Pub. Date: Aug. 11, 2022

(54) SEAMLESS FEATURE ACCESS FOR A DEVICE THROUGH A DEVICE MANAGEMENT SERVER

(71) Applicant: MOTOROLA SOLUTIONS, INC., Chicago, IL (US)

(72) Inventors: Jonathan Chan, Bukit Mertajam (MY); Addam L. Krucek, Crystal Lake, IL (US)

(21) Appl. No.: 17/170,490

(22) Filed: Feb. 8, 2021

(51) Int. Cl. H04L 29/06; G06Q 20/04

(52) U.S. Cl. CPC H04L 63/102; G06Q 20/047; H04L 63/0876; H04L 63/0807

(57) ABSTRACT

A system and method for enabling feature access for a device. The system includes a database including a plurality of stored unique identifiers, each one of the stored unique identifiers associated with one of a plurality of electronic devices. The system also includes an electronic processor configured to receive, from an electronic device, a request for access to a feature, the request including a unique identifier of the electronic device, validate the request for access by comparing the unique identifier to the plurality of stored unique identifiers to verify an identity of the electronic device, and transmit a token request to a feature server configured to provide the feature. The electronic processor is further configured to receive, from the feature server, a token in response to the token request, and transmit the token to the electronic device.

### BACKGROUND OF THE INVENTION

Enterprises may provide employees, clients, and/or customers electronic devices for temporary use. A device management server may be utilized to facilitate the implementation, operation, and maintenance of such devices.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a device management system for enabling feature access for a device in accordance with some embodiments.

FIG. 2 is a block diagram of a token utilized by the system of FIG. 1 in accordance with some embodiments.

FIG. 3 schematically illustrates a server included in the system of FIG. 1 in accordance with some embodiments.

FIG. 4 is a flowchart of a method for enabling feature access for a device implemented by the server of FIG. 3 in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

As noted, enterprises may utilize device management server systems for managing a plurality of electronic devices. For example, public safety agencies may utilize such systems to track personal communication devices (for example, radios, computers, electronic tablets, and the like).

The enterprise may eventually want one or more of the electronic devices to utilize one or more add-on services (collectively referred to herein as “features”) provided by one or more third party systems (for example, a third-party cloud service). To access a feature from a third-party system, the electric device may need to establish secure communication (for example, using a token-based session) between itself and a gateway of the third-party system. However, in such instances, there may not be a suitably secure communication means that the third party system can use to provide an authentication token to the electronic device for establishing a secure connection without some human intervention (which may not be an option when the electronic devices are already being utilized outside of a facility of the enterprise). The electronic device may also not have all the information that the third-party system requires to authenticate the electronic device, to generate a properly designated authentication token for the electronic device, or both. Furthermore, device management systems that are implemented on a cloud-based internet of things (IoT) system may have a size limitation for the device shadows/twins of the electronic devices (a record including state and identification information of a particular device). Consequently, an authentication token, which may have an expandable size, may not be able to be cached in the corresponding device shadow.

Accordingly, systems and methods are provided herein for, among other things, the integration of third-party services into a device management system, which allows for seamless granting and revoking of a feature of a third-party system for an electronic device.

One example embodiment provides a cloud-based device management system for enabling feature access for a device. The system includes a database including a plurality of stored unique identifiers. Each one of the stored unique identifiers is associated with one of a plurality of electronic devices. The system also includes an electronic processor configured to receive, from an electronic device, a request for access to a feature. The request includes a unique identifier of the electronic device. The electronic processor is also configured to validate the request for access by comparing the unique identifier to the plurality of stored unique identifiers to verify an identity of the electronic device, and to transmit a token request to a feature server configured to provide the feature. The electronic processor is further configured to receive, from the feature server, a token in response to the token request, and transmit the token to the electronic device.

Another example embodiment provides a method for enabling feature access for a device via a cloud-based device management system. The method includes receiving at the cloud-based device management system, from an electronic device, a request for access to a feature. The request includes a unique identifier of the electronic device. The method also includes validating the request for access by comparing the unique identifier to a plurality of stored unique identifiers to verify an identity of the electronic device, each one of the stored unique identifiers associated with one of a plurality of electronic devices, and transmitting a token request to a feature server configured to provide the feature. The method further includes receiving, from the feature server, a token in response to the token request and transmitting the token to the electronic device.

Another example embodiment provides a cloud-based device management server for enabling feature access for a device. The server includes a database including a plurality of stored unique identifiers. Each one of the stored unique identifiers is associated with one of a plurality of electronic devices and an electronic processor. The electronic processor is configured to receive, from an electronic device, a request for access to a feature. The request includes a unique identifier of the electronic device. The electronic processor is configured to validate the request for access by comparing the unique identifier to the plurality of stored unique identifiers to verify an identity of the electronic device and transmit a token request to a feature server configured to provide the feature. The processor is further configured to receive, from the feature server, a token in response to the token request, and transmit the token to the electronic device.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. For example, it should be understood that although the systems herein depict components as logically separate, such depictions are merely for illustrative purposes. In some embodiments, the illustrated components may be combined or divided into separate software, firmware and/or hardware. These components may be executed on the same computing device or may be distributed among different computing devices connected by one or more networks or other suitable communication means.

For ease of description, some or all of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

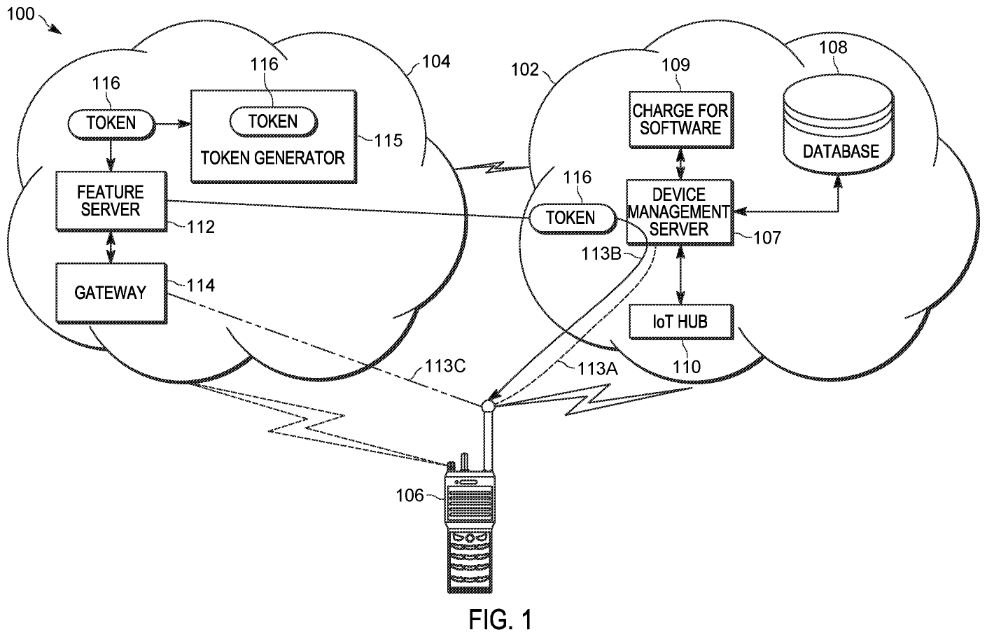

FIG. 1 illustrates an exemplary system 100 for providing access to a feature of a third-party system to an electronic device through a device management system. The system 100 includes a device management system 102, a third-party feature system 104, and an electronic device 106. As illustrated, the device management system 102, the third-party feature system 104, and the electronic device 106 are communicatively coupled over one or more wireless or wired networks (not shown). As described herein, electronic communications are exchanges between the device management system 102, the third-party feature system 104, and the electronic device 106 over communication paths 113A-113C.

The device management system 102 includes a device management server 107 and a database 108. The device management server 107 is configured to communicate with one or more electronic devices (for example, the electronic device 106). In some embodiments, the device management server 107 communicates with the electronic device 106 via an authenticated communication past 113A. In some embodiments, the device management system 102 may include or be an Internet of Things (IoT) network. An IoT network is a network of physical devices, vehicles, appliances, and other items embedded with electronics, software, sensors, actuators, and connectivity which enables these objects to connect and exchange data. For example, in some embodiments, the device management system 102 includes an Internet of Things (IoT) hub 110, which the server 107 utilizes to communicate with the one or more electronic devices including electronic device 106 that are part of the IoT network. The IoT hub 110 may be implemented on the device management server 107 or a separate server (not shown).

The device management server 107 manages information regarding the electronic device 106. Such information includes, for example, one or more unique identifiers of the electronic device 106. Examples of unique identifiers of the electronic device 106 include a serial number, an international mobile equipment identity (IMEI), a media access control address (MAC address), an international mobile subscriber identity (IMSI), and/or the like. A unique identifier may also be used to identify a specific part/component of the electronic device 106. In some embodiments, the unique identifier is a part number of a component of the electronic device 106. For example, the unique identifier may be an integrated circuit card identity (for example, a serial number or ICCID of a subscriber identity module or SIM).

As illustrated in FIG. 1, the device management server 107 is communicatively coupled with the database 108. The database 108 may be a database housed on a suitable database server communicatively coupled to and accessible by the device management server 107. In alternative embodiments, the database 108 is part of a cloud-based database system external to the system 100 and accessible by the device management server 107 over one or more additional networks. Also, in some embodiments, all or part of the database 108 is locally stored on the device management server 107. The database 108 includes a plurality of stored unique identifiers. Each one of the stored unique identifiers is associated with one of a plurality of electronic devices including the electronic device 106. The database 108 may include additional information of each of the plurality of electronic devices. It should be understood that, in some embodiments, the data stored in the database 108 is distributed among multiple databases that communicate with the device management server 107.

In some embodiments, the device management system 102 includes a charge for software framework 109. The charge for software framework 109 is a framework that provides one or more features of one or more respective third-party systems (for example, the third-party system 104 described below) for purchase in order for access. A feature may be purchased for one or more particular electronic devices (for example, the electronic device 106) managed by the device management system 102.

The third-party system 104 is a network that includes one or more entities (such as other networks, servers, and devices) and is configured to provide one or more services or applications (collectively referred to herein as features) to end users and devices that are registered or activated with the service network. Such features may include cellular data services, push-to-talk (PTT) communications, device management, a virtual partner application, and the like.

In the example shown, the third-party system 104 includes a feature server 112. The feature server 112 is configured to manage access to and provide one or more features (for example, a software application/extension) to a client electronic device. A client electronic device (for example, the electronic device 106) may access (following an authentication) the one or more features provided by the system 104/server 112 through a gateway 114 of the system 104. The gateway 114 may be implemented on the feature server 112 or a separate server (not shown). The third-party system 104 and the device management system 102 are implemented on separate cloud-based platforms.

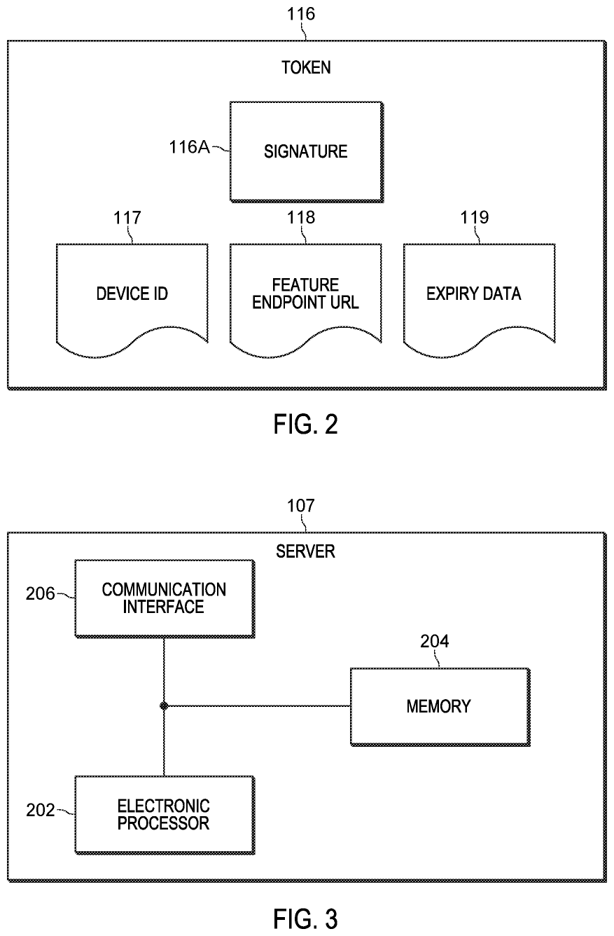

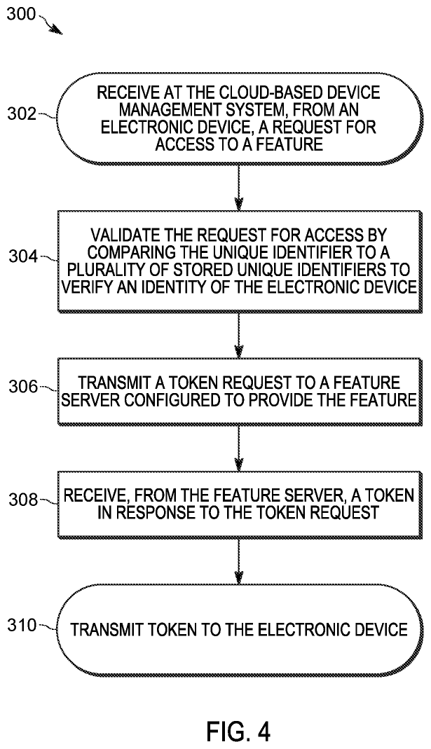

The third-party system 104 also includes token generator 115. As explained in more detail below, the token generator 115 generates a token 116 for a particular electronic device 106 that is to be provided access to a feature provided by the third-party system 104 (for example, in response to a purchase for software through the charge for software framework 109). As illustrated in FIG. 2, in some embodiments, the token 116 is embedded with a signature 116A for validating the token, which is unique to the requesting device. In some embodiments, the token 116 is also embedded with a device identifier 117 (identifying the electronic device 106), a regionalized feature endpoint URL 118 (for example, identifying where the electronic device 106 can access the feature), an expiry date & time 119 of the token 116, and other payload data (not shown). Returning to FIG. 1, in some embodiments, the third-party system 104 transmits the token 116 to the device management server 107 and on to the electronic device 106 (for example, via a communication channel 113B). The electronic device 106 utilizes the token 116, once received from the third-party system 104 (for example, via the method 300 FIG. 4 described below with respect to FIG. 4), to establish a secure communication channel 113C between the electronic device 106 and the third-party system 104 (for example, through the gateway 114). In some embodiments, the token 116 is a JSON Web Token (JWT).

The electronic device 106 may be any sort of communication device utilized by an end user. The electronic device 106 may be, for example, a radio, a smart phone, a converged device (for example, a LTE and LMR converged device), a tablet computer, a personal digital assistant (PDA), or another device that includes or can be connected to a network modem or components to enable wireless network communications (such as a baseband processor, memory, amplifier, antenna, and the like). The electronic device 106 includes software for execution by the processor, and a non-volatile memory or other memory location for storing a subscription profile (that is, authentication data and network profile data including, for example, a device certificate). The non-volatile memory may be located on an integrated circuit card or universal integrated circuit card (UICC) in the portable communication device. In some embodiments, the portable communication device includes a wired communications module (for example, Ethernet or USB), via which the processor is operable to communicate.

In the illustrated embodiment, the electronic device 106 is communicatively coupled to the device management server system 102. As explained in more detail below, in one example, the electronic device 106 establishes a communication link to the third-party system 104/feature server 112 through the method 300 (FIG. 4) implemented by the device management system 102 (in particular, the device management server 107). In some embodiments, the electronic device 106 is an IoT device configured to communicate with the system 102 through the IoT hub 110.

Each communication link of the system 100, including those between the components of the systems 102 and 104, may be wired or implemented wirelessly, for example, using a wide area network, such as the Internet, a Long Term Evolution (LTE) network, a Global System for Mobile Communications (or Groupe Special Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, a local area network, for example a Wi-Fi network, a personal area network, for example a Bluetooth™ network, and combinations or derivatives thereof.

It should be understood that the system 100 is provided as an example and, in some embodiments, the system 100 may include additional components. For example, the system 100 may include one or more databases including the database 108. The system 100 also includes, in further embodiments, multiple device management servers 102, feature servers 112, or combinations thereof. While only a single electronic device 106 is illustrated, the system 100 may include more than one electronic device 106. The related methods described herein may be applied to more than one electronic device 106 concurrently. It should also be understood that one or more of the systems 102 and 104 may be cloud-based systems. In some embodiments, one or more of the components of the system 100 are implemented virtually.

FIG. 3 schematically illustrates the device management server 107 in more detail. As illustrated in FIG. 3, the device management server 107 includes an electronic processor 202, (for example, a microprocessor, application-specific integrated circuit (ASIC), or another suitable electronic device), a memory 204 (for example, a non-transitory, computer-readable storage medium), and a communication interface 206, such as a transceiver, for communicating over the system 100 and, optionally, one or more additional communication networks or connections.

The memory 204 may include a program storage area and a data storage area. The processor 202 is connected to the memory 204 and executes computer readable code (“software”) stored in a random access memory (RAM) of the memory (for example, during execution), a read only memory (ROM) of the memory (for example, on a generally permanent basis), or another non-transitory computer readable medium. Software included for the processes and methods for identification and configuration of each electronic device can be stored in the storage memory 204. The software may include firmware, one or more applications, program data, filters, rules, one or more program modules, and/or other executable instructions. The processor 202 is configured to retrieve from the memory 204 and execute, among other things, instructions related to the processes and methods described herein (for example, the method 300 of FIG. 4 described below). In some embodiments, some or all of the software and data stored in the memory 204 may also be stored in and retrieved from the database 108. For example, the memory 204 may include identification information of the device 106 (for example, the unique identifier).

The electronic processor 202, the memory 204, and the communication interface 206 included in the device management server 107 communicate over one or more communication lines or buses, or combination thereof. As described more particularly below, in some embodiments, the device management server 107 stores and exchanges information regarding one or more electronic devices (for example, electronic device 106) with the third party system 104 (in particular, the feature server 112) or to other computing devices (not shown). The feature server 112 and the electronic device 106 also include similar components as the device management server 107.

It should be understood that the device management server 107 may include additional components than those illustrated in FIG. 3 in various configurations and may perform additional functionality than the functionality described in the present application. Also, it should be understood that the functionality described herein as being performed by the device management server 107 may be distributed among multiple devices, such as multiple servers, and may be provided through a cloud computing environment, accessible by components of the system 100. For example, in some embodiments, the memory 204 is part of the database 108.

FIG. 4 illustrates a method 300 for a method for enabling feature access for an electronic device (for example, the electronic device 106) implemented by the device management system 102. Using method 300, the electronic device 106 is able to seamlessly (with little to no human intervention) access a feature provided by the third-party system 104 through the device management system 102 (in particular, the device management server 107). The method 300 is described below as being implemented by the device management server 107 (in particular, the electronic processor 202). Although the method 300 is described below in terms of a single electronic device 106, the method 300 may be implemented for more than one electronic device.

At block 302, the electronic processor 202 receives, from the electronic device 106, a request for access to a feature provided by the third-party feature system 104/feature server 112. The request includes a unique identifier of the electronic device 106 (for example, one or more of those described above with regard to FIG. 1). As explained above, the unique identifier (or identifiers) may be/include a serial number of the electronic device 106, an international mobile equipment identity, and an integrated circuit card identity. In some embodiments, the electronic device 106 transmits the request in response to receiving (for example, via the IoT hub 110) a new feature enablement request from the electronic processor 202. The electronic processor 202 may transmit the new feature enablement request when a user of the system 102 purchases/subscribes to a feature of the third-party system 104 (for example, through the charge for software framework 109), to which the electronic device 106 does not have access. The new feature enablement request may be transmitted, for example, via the IoT hub 110.

At block 304, the electronic processor 202 validates the request for access by comparing the unique identifier to the plurality of stored unique identifiers of the database 108 to verify an identity of the electronic device 106. In some embodiments, validating the request for access includes validating a certificate of the electronic device 106. In validating the request, the electronic processor 202 may also use the unique identifier to validate that the feature being requested was purchased for the particular electronic device 106. Upon verification of the identity of the electronic device 106 (for example, via the device certificate), the electronic processor 202 may establish an authenticated connection between the server 107 and the electronic device 106 (for example, the communication channel 113A of FIG. 1). In some embodiments, the electronic processor 202 communicates via the authenticated connection through the IoT hub 110.

If the electronic processor 202 is unable to validate the request for access or verify the identity of the electronic device 106, the method 300 may end. Otherwise, at block 306, the electronic processor 202 transmits a token request to a feature server configured to provide the requested feature (here, the feature server 112). In some embodiments, the token request is received by the feature server 112 at the gateway 114. The token request includes identifying information of the electronic device 106. For example, the token request may include at least one selected from the group consisting of a device identifier (for example, a phone number), an identifier of a shadow of the device 106 (a record stored at the device management system 102 that includes state and identification information of a particular device), a customer identifier, a customer region, and the like. In some embodiments, the electronic processor 202 includes information from a stored shadow of the electronic device 106.

At block 308, the electronic processor 202 receives (for example, via communication interface 206) a token (for example, the token 116 of FIG. 2) from the feature server 112 in response to the token request (over communication channel 113B of FIG. 1) and, at block 310, transmits the token 116 to the electronic device 106. The token 116 may include information similar to the information included in the token request (for example, the unique identifier of the electronic device 106). The token 116 additionally includes an address (for example, the feature endpoint URL 118) to the gateway 114 of the feature server 112/system 104. The address may be a unique address assigned in particular to the electronic device 106. As noted, in some embodiments, the token 116 includes an expiration date corresponding to a time or duration of time, after which the token will be invalid and/or deleted.

At the feature server 112, the information included within the token request is utilized to verify that the electronic device 106 is to be granted access to (that is, that a user of the device 106 purchased/subscribed to, for example, through the charge for software framework 109) the feature provided by the feature server 112. In some embodiments, the feature server 112 may establish a secure connection between itself and the device management server 107 upon receipt of the token request to access the shadow of the electronic device 106 (for example, to verify the identity of the electronic device 106 and/or to collect additional information). The feature server 112 may utilize the information from the shadow of the device 106 in the generation of the token 116 so that the token 116 is embedded with a signature 116A and other information unique to the electronic device 106. Thus, access management to the feature for a particular electronic device is managed at the feature server 112/third party system 104 rather than the device management system 102.

Upon receipt of the token 116 (for example, via the IoT hub 110), the electronic device 106 utilizes the information from the token to establish a secure, direct connection to the feature server 112 (for example, through the gateway 114, creating the communication channel 113C of FIG. 1). In some embodiments, the necessary client for utilization of the feature onto the electronic device 106 may then be installed. The feature client on the electronic device 106 may then track the expiry time of the token 116 and request a new token directly from the feature server 112 prior to the expiration of the token as necessary.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A cloud-based device management system for enabling feature access for a device, the system comprising:
a database including a plurality of stored unique identifiers, each one of the stored unique identifiers associated with one of a plurality of electronic devices;
an electronic processor configured to
receive, from an electronic device, a request for access to a feature, the request including a unique identifier of the electronic device,
validate the request for access by comparing the unique identifier to the plurality of stored unique identifiers to verify an identity of the electronic device,
transmit a token request to a feature server configured to provide the feature,
receive, from the feature server, a token in response to the token request, and
transmit the token to the electronic device.

2. The system of claim 1, wherein validating the request for access includes validating a certificate of the electronic device and confirming that the feature being requested was purchased for the electronic device.

3. The system of claim 2, wherein the electronic processor transmits the token to the electronic device over a device certificate authenticated connection.

4. The system of claim 1 further comprising an Internet-of-Things hub and wherein the electronic processor is configured to communicate with the electronic device through Internet-of-Things hub.

5. The system of claim 1, wherein access management of the feature is performed at the feature server.

6. The system of claim 1, wherein the token includes an address to the feature unique to the electronic device.

7. A method for enabling feature access for a device via a cloud-based device management system, the method comprising:
receiving at the cloud-based device management system, from an electronic device, a request for access to a feature, the request including a unique identifier of the electronic device;
validating the request for access by comparing the unique identifier to a plurality of stored unique identifiers to verify an identity of the electronic device, each one of the stored unique identifiers associated with one of a plurality of electronic devices;
transmitting a token request to a feature server configured to provide the feature;
receiving, from the feature server, a token in response to the token request; and
transmitting the token to the electronic device.

8. The method of claim 7, wherein validating the request for access includes validating a certificate of the electronic device and confirming that the feature being requested was purchased for the electronic device.

9. The method of claim 8, wherein the token is transmitted to the electronic device over a device certificate authenticated connection.

10. The method of claim 7, wherein the system further comprising an Internet-of-Things hub and wherein the system is configured to communicate with the electronic device through Internet-of-Things hub.

11. The method of claim 7, wherein access management of the feature is performed at the feature server.

12. The method of claim 7, wherein the token includes an address to the feature unique to the electronic device.

13. A cloud-based device management server for enabling feature access for a device, the server comprising:
a database including a plurality of stored unique identifiers, each one of the stored unique identifiers associated with one of a plurality of electronic devices;
an electronic processor configured to
receive, from an electronic device, a request for access to a feature, the request including a unique identifier of the electronic device,
validate the request for access by comparing the unique identifier to the plurality of stored unique identifiers to verify an identity of the electronic device,
transmit a token request to a feature server configured to provide the feature,
receive, from the feature server, a token in response to the token request, and
transmit the token to the electronic device.

14. The server of claim 13, wherein validating the request for access includes validating a certificate of the electronic device and confirming that the feature being requested was purchased for the electronic device.

15. The server of claim 14, wherein the electronic processor transmits the token to the electronic device over a device certificate authenticated connection.

16. The server of claim 13 further comprising an Internet-of-Things hub and wherein the electronic processor is configured to communicate with the electronic device through Internet-of-Things hub.

17. The server of claim 13, wherein access management of the feature is performed at the feature server.

18. The server of claim 13, wherein the token includes an address to the feature unique to the electronic device.
